(19) United States
(12) Patent Application Publication
(10) Pub. No.: US 2018/0278616 A1
(43) Pub. Date: Sep. 27, 2018

(54) IN-VEHICLE COMMUNICATION SYSTEM, COMMUNICATION MANAGEMENT DEVICE, AND VEHICLE CONTROL DEVICE

(71) Applicants: Hiroki Sakamoto, Aichi (JP); Yosuke Tomita, Aichi (JP); Tetsuo Nishidai, Aichi (JP)

(72) Inventors: Hiroki Sakamoto, Aichi (JP); Yosuke Tomita, Aichi (JP); Tetsuo Nishidai, Aichi (JP)

(73) Assignee: OMRON AUTOMOTIVE ELECTRONICS CO., LTD., Aichi (JP)

(21) Appl. No.: 15/918,616

(22) Filed: Mar. 12, 2018

(30) Foreign Application Priority Data
Mar. 21, 2017 (JP) 2017-054112

(51) Int. Cl. H04L 29/06; G07C 5/08

(52) U.S. Cl. CPC H04L 63/10; H04L 67/12; G07C 5/0816

(57) ABSTRACT

An in-vehicle communication system includes vehicle control devices and a communication management device connected to a network. The communication management device includes: an abnormality detection unit that detects an abnormality and a kind of the abnormality on the basis of reception information received from any one of the vehicle control devices during communication between the vehicle control devices; an abnormality notification unit that notifies the other vehicle control devices of the kind of the abnormality in correspondence with the kind of the abnormality; and a transmission control unit that transmits the reception information to the other vehicle control devices in correspondence with the kind of the abnormality. The vehicle control devices execute a predetermined control in correspondence with the kind of the abnormality that is given in notification from the communication management device.

### CROSS-REFERENCES TO RELATED APPLICATIONS

This application is based upon and claims the benefit of priority from Japanese Patent Application No. 2017-054112, filed on Mar. 21, 2017, the entire contents of which are incorporated herein by reference.

### FIELD

One or more embodiments of the present invention relate to an in-vehicle communication system that manages communication between vehicle control devices by a communication management device in a network constructed in a vehicle.

### BACKGROUND

For example, a plurality of vehicle control devices are mounted in a vehicle such as an automatic four-wheel vehicle. The vehicle control devices are constituted by an electronic control unit (ECU). Each of the vehicle control devices is connected to a predetermined node such as a controller area network (CAN) and a local interconnect network (LIN) of a network constructed in the vehicle. Each of the vehicle control devices transmits and receives information, which is necessary for a control of an in-vehicle apparatus that is an object to be controlled, to and from other vehicle control devices. In addition, the vehicle control devices communicate with each other for a cooperative operation. A communication management device is connected to the network to manage communication between the vehicle control devices. The communication management device also communicates with the vehicle control devices.

A plurality of networks may be constructed in a vehicle. In this case, the communication management device is connected to the plurality of networks, and communication between vehicle control devices, which are respectively connected to networks different from each other, is established through the communication management device. Specifically, during communication between the vehicle control devices which are respectively connected to networks different from each other, the communication management device subjects information received from vehicle control devices on one network to filtering processing, and relays (transmit) the resultant information to vehicle control devices on another network or excludes (does not transmit) the information. In addition, in a case where the one network and the other network are different in a communication protocol, the communication protocol of information is converted by the communication management device during communication between the vehicle control devices over the networks.

The filtering processing and/or the communication protocol conversion processing by the communication management device are collectively called gateway processing. The communication management device is also constituted by an ECU. The communication management device is called a gateway device, a gateway ECU, a communication management ECU, and the like. In contrast, the vehicle control device is called a local device, a local ECU, and the like. An in-vehicle communication system, which includes the communication management device and the plurality of vehicle control devices, is disclosed in JP-A-2015-88941, JP-A-2016-131325, and JP-A-2005-204084.

In the in-vehicle communication system, when a person who intends to carry out an unauthorized conduct (hereinafter, referred to as “unauthorized user”) installs a unauthorized device on a network and transmits unauthorized information from the unauthorized device, there is a problem that communication between the vehicle control device is interrupted or the vehicle control devices may malfunction. According to this, in JP-A-2015-88941, JP-A-2016-131325, and JP-A-2005-204084, an abnormality is detected on the basis of information (including data or signals) which the communication management device receives from the vehicle control devices.

In JP-A-2015-88941, a gateway ECU determines communication reliability on the basis of data or signals which are contained in a message and are capable of confirming reliability when reception of the message from one local ECU is completed or during reception of the message. At this point of time, in a case where a communication result is normal, the gateway ECU continues gateway transmission with respect to other local ECUs. In contrast, in a case where the communication result is abnormal, the gateway transmission is stopped, or an abnormality message is added to gateway transmission data.

In JP-A-2016-131325, a monitoring device samples a voltage of a communication line a plurality of times over a predetermined period, and detects an abnormality of a plurality of local ECUs connected to the communication line on the basis of the result. In addition, the monitoring device notifies the plurality of local ECUs of the abnormality, and performs predetermined information transmission with respect to the communication line to interrupt information reception by the plurality of local ECUs.

In JP-A-2005-204084, a communication management ECU receives identification information from respective local ECUs and registers a communication-possible local ECU in a list. In addition, the communication management ECU receives adjacent port information, which indicates a connection state of other local ECUs with respect to connection ports (nodes) adjacent to the respective local ECUs, from the respective local ECUs. In addition, in a case where a local ECU corresponding to the adjacent port information is not registered in the list, the communication management ECU registers the local ECU in a list as a local ECU in which a communication failure occurs, and transmits the list to the local ECUs. The local ECUs refer to the list to understand whether or not a communication failure occurs in a counterpart local ECU that is in a cooperative operation or the counterpart local ECU is not mounted in a vehicle, and thus an operation of the local ECUs becomes possible.

### SUMMARY

In an in-vehicle communication system of the related art, during communication between vehicle control devices through a communication management device, when detecting an abnormality on the basis of information received from the vehicle control device, the communication management device takes a measure such as stopping of the communication between the vehicle control devices, or not-relaying of the information from the viewpoint of ensuring security. However, according to this, even though the information is necessary for the vehicle control devices, there is a possibility that the information is not received by the vehicle control devices, and the thus the vehicle control devices cannot appropriately perform a control.

In addition, when detecting an abnormality on the basis of information received from any one of the vehicle control devices, the communication management device may transmit the information to other vehicle control devices in combination with abnormality notification. However, in this case, for example, in a case where an abnormality such as denial of service (DOS) attack in which a large pieces of information are transmitted from an unauthorized device occurs, the large pieces of information is processed by the communication management device or the vehicle control devices, or a network enters a high load state, and thus another communication becomes difficult. In addition, for example, in a case where an abnormality, in which unauthorized information causing the vehicle control devices to malfunction is transmitted from the unauthorized device, occurs, the unauthorized information is relayed by the communication management device, and thus the vehicle control devices which receive the unauthorized information malfunctions.

In addition, when the communication management device performs a control with respect to the vehicle control devices such as stopping the communication between the vehicle control devices and hindering the communication between the vehicle control devices through predetermined information transmission so as to ensure security when detecting an abnormality, a burden on the communication management device increases.

One or more embodiments of the invention reduce the burden on the communication management devices during communication between vehicle control devices through the communication management devices while ensuring communication properties and security.

According to one or more embodiments of the invention, there is provided an in-vehicle communication system including: a plurality of vehicle control devices which are connected to a network constructed in a vehicle and perform a mutual communication so as to control respective units of the vehicle; and a communication management device that is connected to the network and manages communication between the vehicle control devices. During communication between the vehicle control devices, information transmitted from any one of the vehicle control devices is received by other vehicle control devices through the communication management device. The communication management device includes an abnormality detection unit that detects an abnormality and a kind of the abnormality on the basis of reception information that is received from the any one of the vehicle control devices during communication between the vehicle control devices, an abnormality notification unit that notifies the other vehicle control devices of the kind of the abnormality in correspondence with the kind of the abnormality, and a transmission control unit that transmits the reception information to the other vehicle control devices in correspondence with the kind of the abnormality. The vehicle control devices execute a predetermined control in correspondence with the kind of the abnormality that is given in notification from the communication management device.

In addition, according to one or more embodiments of the invention, there is provided a communication management device that is connected to networks constructed in a vehicle, manages communication between a plurality of vehicle control devices which are connected to the networks, receives information transmitted from any one of the vehicle control devices in communication between the vehicle control devices, and transmits the reception information to other vehicle control devices. The communication management device includes: an abnormality detection unit that detects an abnormality and a kind of the abnormality in communication between the vehicle control devices on the basis of the reception information received from the any one vehicle control device; an abnormality notification unit that notifies the other vehicle control devices of the kind of the abnormality in correspondence with the kind of the abnormality; and a transmission control unit that transmits the reception information to the other vehicle control devices in correspondence with the kind of the abnormality.

In addition, according to one or more embodiments of the invention, there is provided a vehicle control device. A plurality of the vehicle control devices are connected to networks constructed in a vehicle to perform a mutual communication, and control respective units of the vehicle. Information transmitted from any one of the vehicle control devices is received by other vehicle control devices through a communication management device connected to the networks in communication between the vehicle control devices. The vehicle control devices receive an abnormality notification message, which includes an abnormality detected by the communication management device on the basis of the information that is transmitted, and a kind of the abnormality, from the communication management device, receive the information, which is transmitted, from the communication management device in correspondence with the kind of the abnormality, and execute a predetermined control in correspondence with the kind of the abnormality included in the abnormality notification message.

According to one or more embodiments of the invention, the communication management device detects abnormality and the kind of the abnormality on the basis of reception information received from any one of the vehicle control devices, and notifies other vehicle control devices of the kind of the abnormality in corresponding with the kind of the abnormality. In addition, the communication management device transmits the reception information to other vehicle control devices in correspondence with the kind of the abnormality. In addition, the vehicle control devices execute a predetermined control in correspondence with the kind of the abnormality given in notification from the communication management device, and perform a predetermined control on the basis of information received from other vehicle control devices through the communication management device. According to this, the communication management device and the vehicle control devices are allowed to appropriately operate in correspondence with the kind of an abnormality that occurs in communication between the vehicle control devices through the communication management device, and thus it is possible to ensure communication properties between the vehicle control devices and security of the vehicle control devices. In addition, the communication management device does not perform a control with respect to the vehicle control devices in correspondence with detection of an abnormality, and the vehicle control devices perform a control in correspondence with the kind of the abnormality that is given in notification. That is, the vehicle control devices determine the behavior thereof in correspondence with the kind of abnormality given in a notification from the communication management device and spontaneously operate, and thus it is possible to reduce the burden on the communication management device.

In the in-vehicle communication system according to one or more embodiments of the invention, a plurality of the networks may be constructed in the vehicle, the plurality of vehicle control devices and the communication management device as a single common device may be connected to the networks, and the abnormality notification unit of the communication management device may notify the vehicle control devices of the kind of the abnormality in correspondence with the kind of the abnormality detected by the abnormality detection unit.

In addition, in the in-vehicle communication system according to one or more embodiments of the invention, the vehicle control devices may switch a security operation for ensuring communication security in correspondence with the kind of the abnormality that is given in notification from the communication management device.

In addition, in the in-vehicle communication system according to one or more embodiments of the invention, in a case where an abnormality is not detected by the abnormality detection unit on the basis of information received again from a vehicle control device, in which an abnormality has been detected, among the vehicle control devices, the communication management device may notify the vehicle control devices, which have been notified of the kind of the abnormality, of abnormality-elimination by using the abnormality notification unit. The vehicle control devices are returned to a control state before notification of the kind of the abnormality in response to the notification of the abnormality-elimination from the communication management device.

In addition, in the in-vehicle communication system according to one or more embodiments of the invention, the abnormality notification unit of the communication management device may execute notification of the kind of the abnormality or notification of the abnormality-elimination a plurality of times at a predetermined period.

In addition, in the in-vehicle communication system according to one or more embodiments of the invention, in a case where the abnormality detection unit of the communication management device detects a period abnormality, in which a large amount of information greater than a constant amount is transmitted in a period that obstructs a normal communication, as the kind of abnormality, the abnormality notification unit of the communication management device may not give a notification of the period abnormality, and the transmission control unit may discard the large amount of information.

In addition, in the in-vehicle communication system according to one or more embodiments of the invention, in a case where the abnormality detection unit of the communication management device detects an identification information abnormality in which identification information, which is included in the reception information received from the any one of the vehicle control devices, of a transmission source is not defined as the kind of abnormality, the abnormality notification unit may not give a notification of the identification information abnormality, and the transmission control unit may transmit the reception information to the other vehicle control devices. In this case, the vehicle control devices may detect the identification information abnormality on the basis of the information received through the communication management device, may store the undefined identification information included in the information, and may exclude the information from an object to be processed even when receiving information including the undefined identification information.

In addition, in the in-vehicle communication system according to one or more embodiments of the invention, in a case where the abnormality detection unit of the communication management device detects an unauthorized information abnormality, in which information received from the any one of the vehicle control devices is unauthorized, as the kind of abnormality, the abnormality notification unit may notify the vehicle control devices of an abnormality message including the unauthorized information abnormality and identification information, which is included in the reception information, of a transmission source, and the transmission control unit may transmit the reception information to the other vehicle control devices. Furthermore, for example, the fraudulence of the received information represents that contents of the information, a format thereof, reception timing thereof, or a transmission source thereof is out of definition or is not valid with respect to a vehicle state at that time. In this case, the vehicle control devices, which are notified of the abnormality message, may store the identification information, which is included in the abnormality message, of the transmission source as unauthorized identification information, may perform authentication of reception information when receiving the information including the unauthorized identification information, and may execute a predetermined control on the basis of the reception information when the authentication succeeds.

According to one or more embodiments of the invention, it is possible to reduce a burden on the communication management devices during communication between vehicle control devices through the communication management devices while ensuring communication properties and security.

### BRIEF DESCRIPTION OF DRAWINGS

FIG. 1 is a configuration diagram of an in-vehicle communication system according to one embodiment of the invention;

FIG. 2 is a configuration diagram of a gateway ECU in FIG. 1;

FIG. 3 is a configuration diagram of local ECUs in FIG. 1;

FIG. 4 is a flowchart illustrating an operation of the in-vehicle communication system of FIG. 1;

FIGS. 5A to 5C are views illustrating an example of information that is communicated between the local ECUs in FIG. 1;

FIGS. 6A and 6B are views illustrating an example of a message that is transmitted from the gateway ECU of FIG. 1 to the local ECUs;

FIG. 7A is a view illustrating an example of a communication abnormality state that occurs in the in-vehicle communication system of FIG. 1;

FIG. 7B is a view illustrating an example of a communication abnormality state that occurs in the in-vehicle communication system of FIG. 1;

FIG. 8 is a view illustrating an example of a storage content of the gateway ECU of FIG. 1; and

FIG. 9 is a view illustrating an example of storage contents of the local ECUs in FIG. 1.

### DETAILED DESCRIPTION

In embodiments of the invention, numerous specific details are set forth in order to provide a thorough understanding of the invention. However, it will be apparent to one of ordinary skill in the art that the invention may be practiced without these specific details. In other instances, well-known features have not been described in detail to avoid obscuring the invention.

Hereinafter, one or more embodiments of the invention will be described with reference to the accompanying drawings. In the drawings, the same reference numeral will be given to the same parts or corresponding parts.

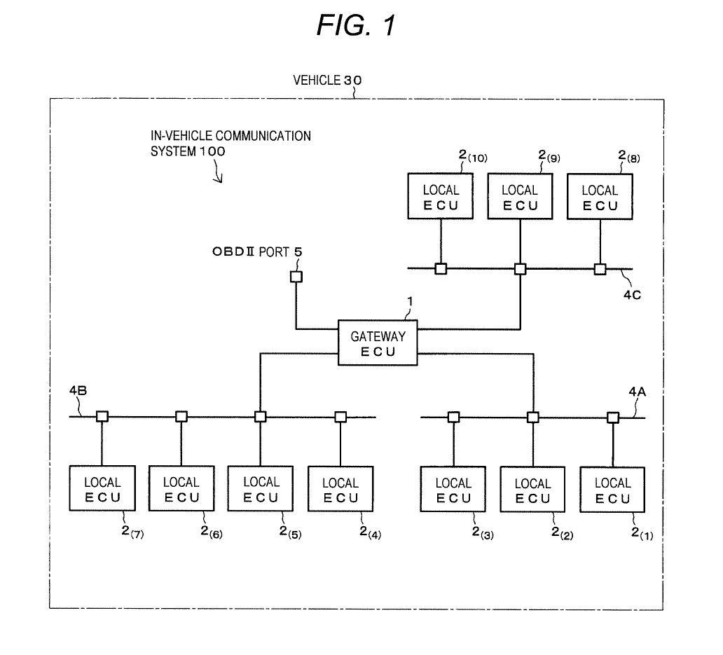

First, a configuration of an in-vehicle communication system 100 of an embodiment will be described with reference to FIG. 1.

FIG. 1 is a configuration diagram of the in-vehicle communication system 100. The in-vehicle communication system 100 is mounted on a vehicle 30 that is a four-wheel vehicle. The in-vehicle communication system 100 includes one gateway electronic control unit (ECU) 1 and a plurality of local ECU 2₍₁₎ to ECU 2₍₁₀₎. In the following description, ECU 2₍₁₎ to ECU 2₍₁₀₎ are collectively described as ECU 2.

In the vehicle 30, a plurality of bus-type networks such as a controller area network (CAN) and a local interconnect network (LIN) are constructed. The plurality of local ECUs 2 are connected to networks of respective buses 4A to 4C.

For example, in FIG. 1, the local ECU 2₍₁₎ to ECU 2₍₃₎ are respectively connected to predetermined connection nodes provided in the network of the bus 4A. In addition, the local ECU 2₍₄₎ to ECU 2₍₇₎ are respectively connected to predetermined connection nodes provided in the network of the bus 4B. In addition, the local ECU 2₍₈₎ to ECU 2₍₁₀₎ are respectively connected to predetermined connection nodes provided in the network of the bus 4C.

The local ECUs 2 control respective units of the vehicle 30. Specifically, each of the local ECUs 2 is allocated for each object to be controlled such as an engine, a brake, a power steering device, an air-conditioner, and an air-bag which are mounted in the vehicle 30, and control the objects. In addition, each of the local ECUs 2 performs a communication to transmit and receive information necessary for an operation control of the in-vehicle apparatus to and from other local ECUs 2. In addition, each of the local ECUs 2 also performs a security operation so as to ensure security of communication with other local ECUs 2. In addition, the local ECUs 2 mutually communicate with each other to perform a cooperative operation.

The single common gateway ECU 1 is connected to networks of the buses 4A to 4C. Specifically, the gateway ECU 1 is connected to predetermined connection nodes of the buses 4A to 4C. The gateway ECU 1 manages communication between the local ECUs 2. The communication management by the gateway ECU 1 is not limited to the same network and is also performed between networks different from each other.

The gateway ECU 1 transmits and receives information to and from the local ECUs 2. During communication between the local ECUs 2 which are connected to the same network, information transmitted from any one of the local ECUs 2 may be directly received by other local ECUs 2, or may be received by other local ECUs 2 through the gateway ECU 1. During communication between the local ECUs 2 which are respectively connected to networks different from each other, information transmitted from any one of the local ECUs 2 is received by other local ECUs 2 through the gateway ECU 1. That is, the communication between the local ECUs 2 is established directly or through the gateway ECU 1.

During communication between the local ECUs 2 through the gateway ECU 1, the gateway ECU 1 subjects information received from the one local ECU 2 to filtering processing, and relays (transmits) the information to other local ECUs 2, or excludes (does not transmit or discards) the information.

Communication protocols of a plurality of local ECUs 2, which are connected to the same network, are the same as each other, but communication protocols of a plurality of local ECUs 2 which are connected to networks different from each other may be the same as or different from each other. In a case where the communication protocols of the plurality of local ECUs 2, which are connected to networks different from each other, are different from each other, the communication protocols are subjected to conversion processing by the gateway ECU 1 during communication between the local ECUs 2.

The filtering processing and/or communication protocol conversion processing by the gateway ECU 1 are collectively called gateway processing. The gateway ECU 1 is an example of “communication management device.” The local ECUs 2 are an example of “vehicle control device.”

An on-board diagnosis second generation (OBDII) port 5 is connected to the gateway ECU 1. A failure diagnosis device (not illustrated) is connected to the OBDII port 5 through a connector or a cable. According to this, for example, the failure diagnosis device can acquire failure diagnosis information of the in-vehicle apparatus from the local ECUs 2 through the gateway ECU 1, or can rewrite a self-diagnosis program with respect to the local ECUs 2.

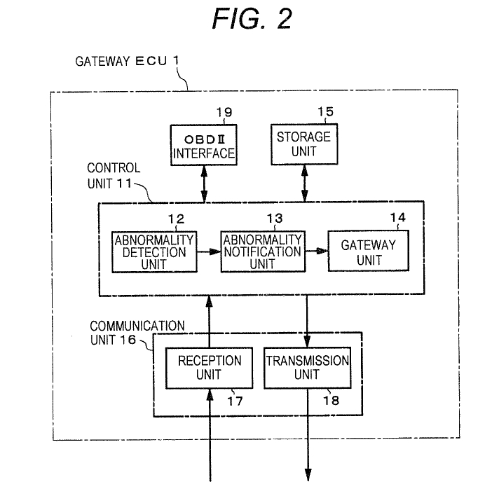

Next, a configuration of the gateway ECU 1 will be described with reference to FIG. 2.

FIG. 2 is a configuration diagram of the gateway ECU 1. The gateway ECU 1 includes a control unit 11, a storage unit 15, a communication unit 16, and OBDII interface 19.

The control unit 11 includes a CPU, a memory, and the like. The storage unit 15 includes a non-volatile memory. Information relating to the networks of the buses 4A to 4C, an ID (identification information) of the local ECUs 2 connected to the networks of the buses 4A to 4C, an ID of the gateway ECU 1, information relating to a communication abnormality, and the like are stored in advance in the storage unit 15. The control unit 11 reads out information from the storage unit 15 or stores the information in the storage unit 15.

The communication unit 16 includes a reception unit 17 and a transmission unit 18 which are configured to perform communication with the local ECUs 2. The reception unit 17 includes a reception circuit configured to receive information from the local ECUs 2. In addition, the transmission unit 18 includes a transmission circuit configured to transmit information to the local ECUs 2. The OBDII interface 19 includes a communication circuit configured to communicate with the failure diagnosis device.

The control unit 11 includes an abnormality detection unit 12, an abnormality notification unit 13, and a gateway unit 14. During communication between the local ECUs 2 through the gateway ECU 1, the abnormality detection unit 12 detects presence or absence of an abnormality in communication with other local ECUs 2 on the basis of information received from the local ECUs 2 by the reception unit 17, and in a case where an abnormality is detected, the abnormality detection unit 12 additionally detects the kind of the abnormality. The control unit 11 determines a local ECU 2 in which an abnormality is present and a local ECU 2 from which an abnormality is eliminated from the detection result of the abnormality detection unit 12.

In correspondence with the kind of the abnormality detected by the abnormality detection unit 12, the abnormality notification unit 13 notifies the local ECUs 2 of an abnormality message including the kind of the abnormality by using the transmission unit 18. The notification is not performed with respect to all kinds of abnormalities, and the notification may or may not be made in accordance with the kind of the abnormality (details thereof will be described later). In addition, in a case where the control unit 11 determines that the abnormality that is given in the notification is eliminated, the abnormality notification unit 13 notifies the local ECUs 2 of an abnormality-elimination message indicating elimination of the abnormality by the transmission unit 18.

During communication between the local ECUs 2 by the gateway ECU 1, the gateway unit 14 subjects information, which is received from any one of the local ECUs 2 by using the reception unit 17 to filtering processing and determines whether or not the information is to be transmitted to other local ECUs 2. At this time, when determining that the information received from the one local ECU 2 is to be transmitted, the gateway unit 14 transmits the information to other local ECUs 2 by using the transmission unit 18 (relay processing). In addition, when determining that the information received from the one local ECU 2 is not transmitted, the gateway unit 14 does not transmit the information to other local ECUs 2 and discards the information (excluding processing).

In addition, during communication between the local ECUs 2 in which communication protocols are different from each other, the gateway unit 14 converts a communication protocol of information received from any one of the local ECUs 2 by the reception unit 17 into a communication protocol that can be received by other local ECUs 2 (communication protocol conversion processing).

In addition, the gateway unit 14 determines whether or not to transmit the information received from the one local ECU 2 by the reception unit 17 to other local ECUs 2 in correspondence with the kind of the abnormality detected by the abnormality detection unit 12. At this time, when determining that the information received by the one local ECU 2 is to be transmitted in correspondence with the kind of the abnormality, the gateway unit 14 transmits the information to other local ECUs 2 by the transmission unit 18. In addition, when determining that the information received from the one local ECU 2 is not transmitted in correspondence with the kind of the abnormality, the gateway unit 14 does not transmit the information to other local ECUs 2 and discards the information. The gateway unit 14 is an example of the “transmission control unit.”

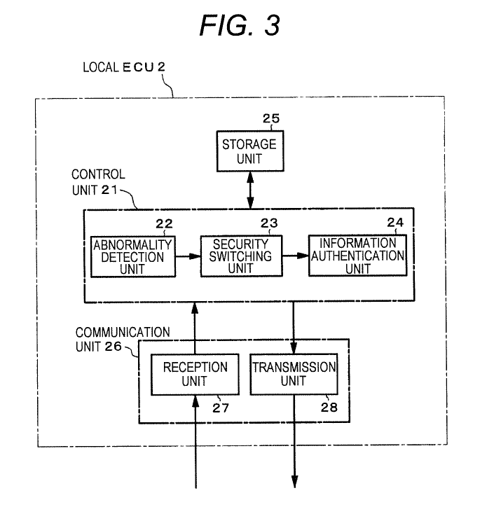

Next, a configuration of the local ECUs 2 will be described with reference to FIG. 3.

FIG. 3 is a configuration diagram of the local ECUs 2. Each of the local ECUs 2 includes a control unit 21, a storage unit 25, and a communication unit 26.

The control unit 21 includes a CPU, a memory, and the like. The storage unit 25 includes a non-volatile memory. Information relating to the networks of the buses 4A to 4C, IDs of the local ECUs 2 connected to the networks of the buses 4A to 4C, an ID of the gateway ECU 1, information relating to a communication abnormality, and the like are stored in advance in the storage unit 25. The control unit 21 reads out information from the storage unit 25 or stores the information in the storage unit 25.

The communication unit 26 includes a reception unit 27 and a transmission unit 28 which are configured to perform communication with other local ECUs 2 or the gateway ECU 1. The reception unit 27 includes a reception circuit configured to receive information from other local ECUs 2 or the gateway ECU 1. In addition, the transmission unit 28 includes a transmission circuit configured to transmit information to other local ECUs 2 or the gateway ECU 1.

The control unit 21 controls an operation of the in-vehicle apparatus that is an object to be controlled. In addition, the control unit 21 transmits and receives information necessary for an operation control of the in-vehicle apparatus, and the like to other local ECUs 2 by using the communication unit 26. The control unit 21 includes an abnormality detection unit 22, a security switching unit 23, and an information authentication unit 24.

When the above-described abnormality message is transmitted from the gateway ECU 1 to the local ECU 2, the abnormality message is received by the reception unit 27. At this time, the abnormality detection unit 22 detects occurrence of an abnormality in communication relating to other local ECUs 2 and the kind of the abnormality on the basis of the abnormality message that is received. In addition, when receiving information transmitted from the other local ECU 2 by the reception unit 27, the abnormality detection unit 22 detects presence or absence of an abnormality on the basis of the information, and in a case where an abnormality is present, the abnormality detection unit 22 detects the kind of the abnormality. The security switching unit 23 switches a security operation for ensuring security of communication with other local ECUs 2 in correspondence with the kind of the abnormality detected by the abnormality detection unit 22.

In addition, when the above-described abnormality-elimination message is transmitted from the gateway ECU 1 to the local ECU 2, the abnormality-elimination message is received by the reception unit 27. At this time, the abnormality detection unit 22 detects that the abnormality in communication relating to other local ECUs 2 is eliminated on the basis of the abnormality-elimination message. In addition, the abnormality detection unit 22 also detects that the previously detected abnormality is eliminated on the basis of information received from other local ECUs 2 by the reception unit 27. The security switching unit 23 returns a security operation to a control state before notification of the abnormality message or before detection of the abnormality by the abnormality detection unit 22 in correspondence with the abnormality-elimination detected by the abnormality detection unit 22.

The information authentication unit 24 performs authentication of information in communication with other local ECUs 2 through the gateway ECU 1 or not through the gateway ECU 1. Specifically, the information authentication unit 24 performs authentication of the information on the basis of authentication information such as encryption keys and counter information which are included in information received by the reception unit 27. The information authentication by the information authentication unit 24 is an example of the security operation, and execution and non-execution of the information authentication are switched by the security switching unit 23. In a case where the information authentication by the information authentication unit 24 is executed, the control unit 21 executes a control of the in-vehicle apparatus on the basis of the information only when authentication of the information received by the reception unit 27 succeeds.

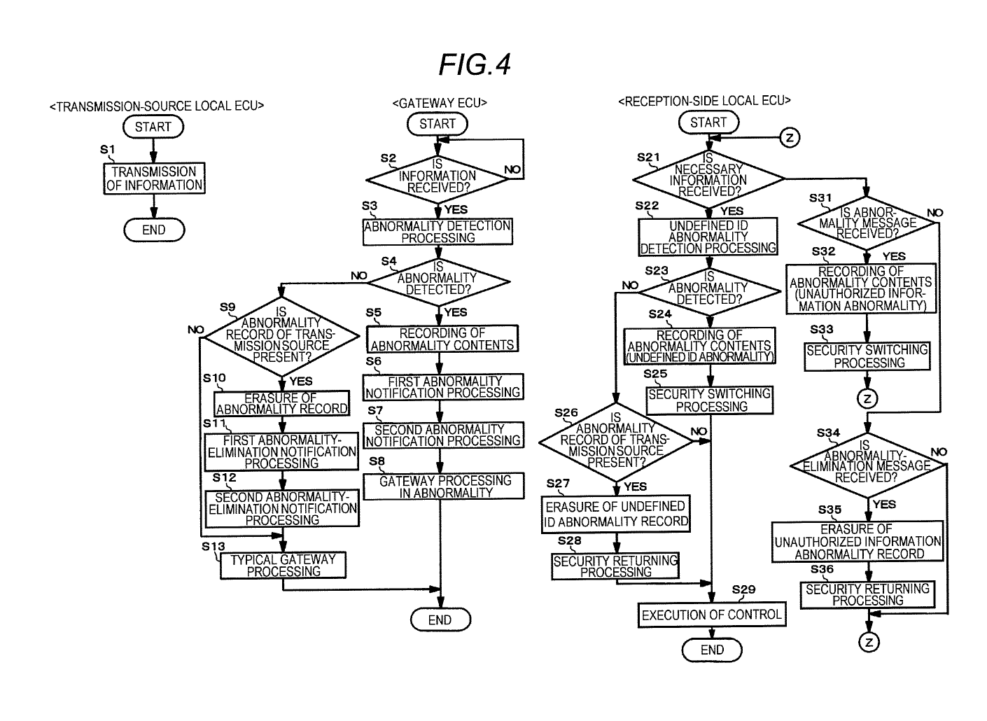

Next, an operation of the in-vehicle communication system 100 will be described with reference to FIG. 4 to FIG. 9.

FIG. 4 is a flowchart illustrating the operation of the in-vehicle communication system 100. FIG. 4 illustrates operations of the gateway ECU 1, a local ECU 2 that is a transmission source of information, and local ECUs 2 on a reception side in communication between the local ECUs 2 through the gateway ECU 1. Furthermore, the local ECUs 2 on a reception side are local ECUs 2 which are combined in the in-vehicle communication system 100 in addition to the local ECU 2 that is a transmission source, and receive information transmitted by the local ECU 2 that is a transmission source through the gateway ECU 1. That is, the local ECUs 2 on the reception side include a local ECU 2 that needs the information transmitted from the local ECU 2 that is a transmission source, and a local ECU 2 that does not need the information.

First, the local ECU 2 that is a transmission source transmits information with respect to at least one of other local ECUs 2 by the transmission unit 28 (step S1 in FIG. 4). At this time, in a case where the local ECU 2 that is a transmission source is in a normal state, normal information is transmitted from the local ECU 2 that is a transmission source.

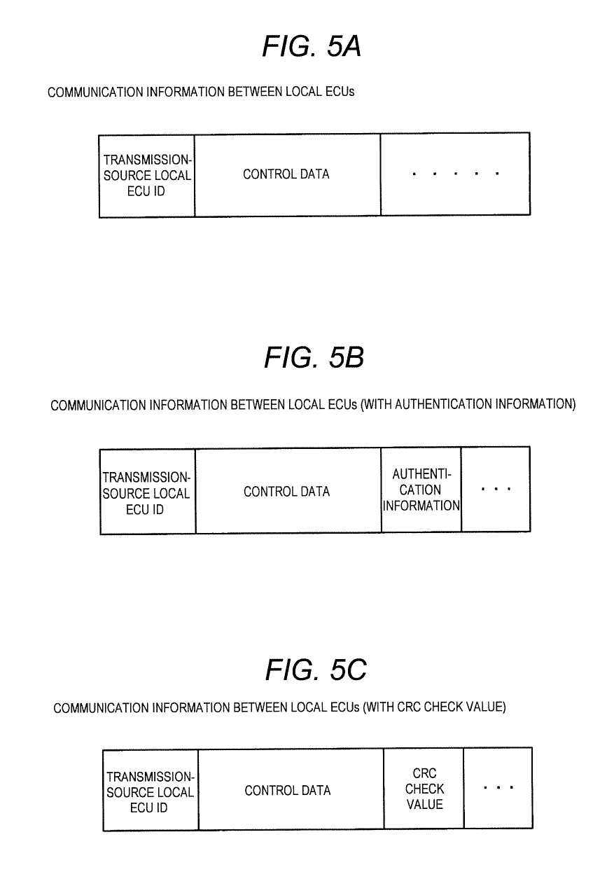

FIGS. 5A to 5C are views illustrating an example of information that is communicated between the local ECUs 2. Information illustrated in FIG. 5A is information transmitted from the local ECU 2 that is a transmission source in the normal state in step S1 in FIG. 4. The information in FIG. 5A includes an ID of a local ECU 2 that is a transmission source, control data, and the like. The control data represents data that is necessary for the local ECUs 2 to control an operation of the in-vehicle apparatus that is an object to be controlled, and the like.

On the other hand, when the local ECU 2 that is a transmission source is attacked by an unauthorized user and the local ECU 2 that is a transmission source enters an abnormal state, in step S1 in FIG. 4, abnormal information is transmitted from the local ECU 2 that is a transmission source. For example, the abnormal information includes information of which a format is different from that of the normal information in FIG. 5A. In addition, for example, the abnormal information also includes information of which a format is the same as that of the normal information illustrated in FIG. 5A but of which contents are improbable as an ID, control data, and the like of the local ECUs 2.

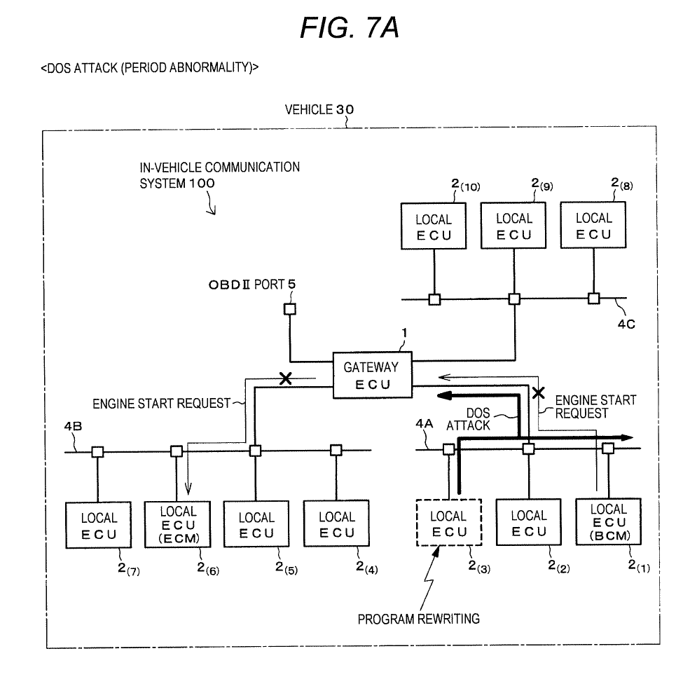

Examples of a case where the local ECU 2 that is a transmission source enters an abnormal state include a case where an unauthorized user connects an unauthorized device to the OBDII port 5, and rewrites a control program of the local ECU 2 that is a transmission source into an unauthorized program by the unauthorized device. In addition, for example, the examples also include a case where the unauthorized user removes a local ECU 2 that is connected to a connection node of any one of the buses 4A to 4C, and connects a false local ECU to the connection node. In a case where the local ECU 2 that is a transmission source enters the abnormal state as described above, for example, as illustrated in FIG. 7A and FIG. 7B, the in-vehicle communication system 100 enters a communication abnormality state.

FIG. 7A and FIG. 7B are views illustrating an example of the communication abnormality state that occurs in the in-vehicle communication system 100. In a case of FIG. 7A, a control program is rewritten into a fault program by an unauthorized user, and the fault program performs denial of service (DOS) attack with respect to the bus 4A to which a local ECU 2₍₃₎, which is the transmission source and enters an abnormal state, is connected. The DOS attack is an example of the period abnormality in which a large amount of information greater than a constant amount is transmitted to a network at a period that obstructs a normal communication of the network. Due to the DOS attack, the network of the bus 4A enters a high load state. In addition, a large amount of information is transmitted to the gateway ECU 1 and the local ECUs 2 which are connected to the bus 4A. Therefore, when the ECUs 1 and 2 try to process the large amount of information, the ECUs 1 and 2 enter a high load state. As a result, other communications in the network of the bus 4A become difficult. In addition, other communications between the network of the bus 4A and networks of the other buses 4B and 4C through the gateway ECU 1 also become difficult. In addition, in a case where the gateway ECU 1 enters a high load state, other communications between the network of the bus 4B and the network of the bus 4C also become difficult.

In the communication abnormality state in FIG. 7A, for example, it is assumed that a user of the vehicle 30 turns on a start switch (not illustrated) to start an engine of the vehicle 30. In this case, information including an engine start request (control data) with respect to the local ECU 2₍₆₎ including an engine control module (ECM) connected to the bus 4B is transmitted from the local ECU 2₍₁₎ including a body control module (BCM) on the bus 4A. However, the bus 4A or the gateway ECU 1 is in a high load state, and thus the information transmitted from the local ECU 2₍₁₎ is less likely to be received by the local ECU 2₍₆₎. An engine is not started by the local ECU 2₍₆₎ as long as the information including the engine start request is not received by the local ECU 2₍₆₎.

In addition, in a case of FIG. 7B, a false BCM imitates the local ECU 2₍₁₎ that enters an abnormal state due to replacement for the local ECU 2₍₁₎ by an unauthorized user. In addition, the local ECU 2₍₁₎ transmits information including a false door unlocking request to the local ECU 2₍₁₀₎ including a door rock module (DRM) without performing authentication of a portable device (electronic key) (not illustrated). The imitation abnormality is an example of unauthorized information abnormality to be described later.

In the communication abnormality state of FIG. 7B, for example, it is assumed that information including the false door unlocking request transmitted from the local ECU 2₍₁₎ is relayed by the gateway ECU 1 and is received by the local ECU 2₍₁₀₎ including a DRM. In this case, a door of the vehicle 30 is unlocked by the local ECU 2₍₁₀₎ against an intention of a valid user, and thus the unauthorized user can enter the inside of the vehicle 30.

As illustrated in FIG. 4, when the information transmitted from the local ECU 2 that is a transmission source is received by the reception unit 17 of the gateway ECU 1 (YES in step S2 in FIG. 4), the abnormality detection unit 12 executes abnormality detection processing on the basis of the information (step S3 in FIG. 4). At this time, the abnormality detection unit 12 detects presence and absence of the abnormality and the kind of the abnormality on the basis of the information received from the local ECU 2 that is a transmission source.

In a case where the information transmitted from the local ECU 2 that is a transmission source is normal information, the abnormality detection unit 12 of the gateway ECU 1 which detects the abnormality does not detect abnormality on the basis of the information (NO in step S4 in FIG. 4). In this case, the control unit 11 determines whether or not an abnormality record of the local ECU 2 that is a transmission source is stored with reference to storage contents of the storage unit 15 (step S9 in FIG. 4).

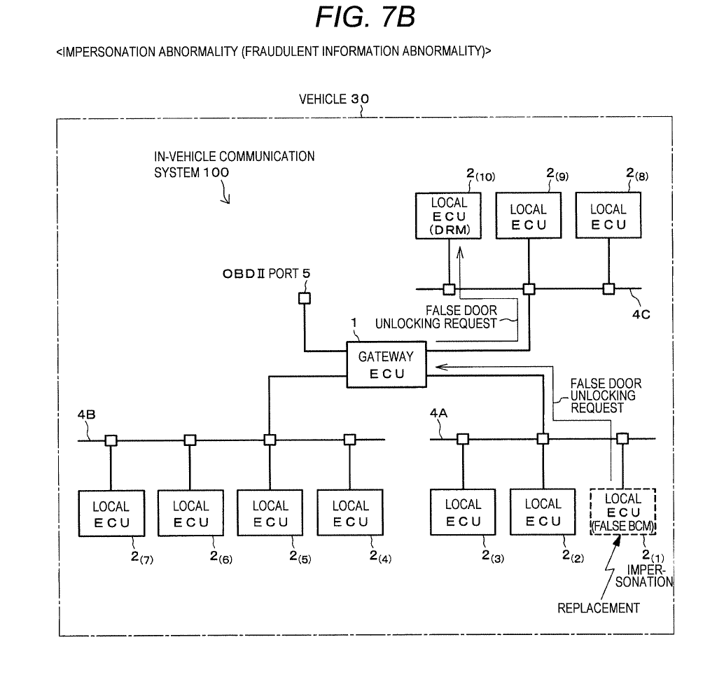

FIG. 8 is a view illustrating an example of the storage contents of the storage unit 15 of the gateway ECU 1. A communication abnormality table T1 relating to the communication abnormality illustrated in FIG. 8 is stored in a predetermined storage region of the storage unit 15. In the communication abnormality table T1, “kind of abnormality” represents the kind of abnormality that can be detected by the abnormality detection unit 12. In this example, examples of the “kind of abnormality” include “period abnormality”, “undefined ID abnormality”, and “unauthorized information abnormality”.

For example, as is the case with the above-described DOS attack, the “period abnormality” is an abnormality in which a large amount of information is transmitted from the local ECUs 2 and the like (including a normal local ECU 2 and an abnormal or false local ECU) in a period that obstructs a normal communication. The “undefined ID abnormality” is an abnormality in which a transmission source ID included in information received from the local ECUs 2 and the like is not defined (is not registered). As another example, an abnormality in which the transmission source ID is not included in the information received from the local ECUs 2 may be included in the “undefined ID abnormality”. The “undefined ID abnormality” is an example of “identification information abnormality.”

The “unauthorized information abnormality” is an abnormality in which contents, a format, reception timing, or a transmission source of reception information received from the local ECUs 2 and the like is unauthorized. For example, fraudulence of the contents of the reception information represents a case where control data includes data that is not communicated between the local ECUs 2 with respect to a state of the vehicle 30 at that time. The fraudulence of the format of the reception information represents a case where a length or capacity of information is beyond definition, or an arrangement of data and the like which are included in the reception information is beyond definition. The fraudulence of the reception timing represents a case where a sequence between the buses 4A to 4C is beyond definition. The fraudulence of the transmission source represents a case where a network of the transmission source is a network other than the buses 4A to 4C, a case where the transmission source of information is an unclear device other than the local ECUs 2, and the like. With regard to the imitation abnormality described in FIG. 7B, the contents or the reception timing of control data of information transmitted from an imitation false local ECU 2 becomes unauthorized, and thus the imitation abnormality is included in the “unauthorized information abnormality”.

“Gateway corresponding operation” in the communication abnormality table T1 of FIG. 8 represents a control operation of the gateway ECU 1 corresponding to the kind of each abnormality. Details thereof will be described later. “Corresponding ECU ID” represents an ID of a local ECU 2 that is a transmission source of information in which the kind of each abnormality is detected.

For example, if an ID that matches the ID, which is included in the information received in step S2 in FIG. 4 of the local ECU 2 that is a transmission source does not exist in a column of “corresponding ECU ID” in the communication abnormality table T1, the control unit 11 determines that an abnormality record of the local ECU 2 that is a transmission source is not stored (NO in step S9 in FIG. 4). In this case, gateway unit 14 executes typical gateway processing (step S13 in FIG. 4). At this time, the information received from the local ECU 2 that is a transmission source is subjected to filtering processing (and/or communication protocol conversion processing) by the gateway unit 14, and the resultant information is transmitted or not transmitted to other local ECUs 2 on a reception side.

With respect to the buses 4A to 4C to which the local ECUs 2 are connected, the local ECUs 2 always try to receive information at a predetermined period by using the reception unit 27. In addition, when receiving information by the reception unit 27, the control unit 21 determines whether or not information necessary for the control unit 21 is received on the basis of the information (step S21 in FIG. 4). According to this, for example, in step S13 in FIG. 4, when information transmitted from the local ECU 2 that is a transmission source is relayed by the gateway ECU 1, and is transmitted to the local ECUs 2 on a reception side, the information is received by the reception unit 27 of the local ECUs 2 on a reception side. In addition, in a local ECU 2 on a reception side in which the control unit 21 determines that necessary information is not received (NO in step S21 in FIG. 4), the received information is discarded. In contrast, in a local ECU 2 on a reception side in which the control unit 21 determines that necessary information is received (YES in step S21 in FIG. 4), the abnormality detection unit 22 executes abnormality detection processing on the basis of the received information (step S22 in FIG. 4). At this time, the abnormality detection unit 22 detects presence or absence of the “undefined ID abnormality” on the basis of information received from the local ECU 2 that is a transmission source through the gateway ECU 1.

For example, in a case where information transmitted from the local ECU 2 that is a transmission source is normal information, the abnormality detection unit 22 of the local ECUs 2 on a reception side, which have received the information through the gateway ECU 1 as necessary information, does not detect an abnormality on the basis of the information (NO in step S23 in FIG. 4). In this case, the control unit 21 determines whether or not an abnormality record of the local ECU 2 that is a transmission source is stored with reference to storage contents of the storage unit 25 (step S26 in FIG. 4).

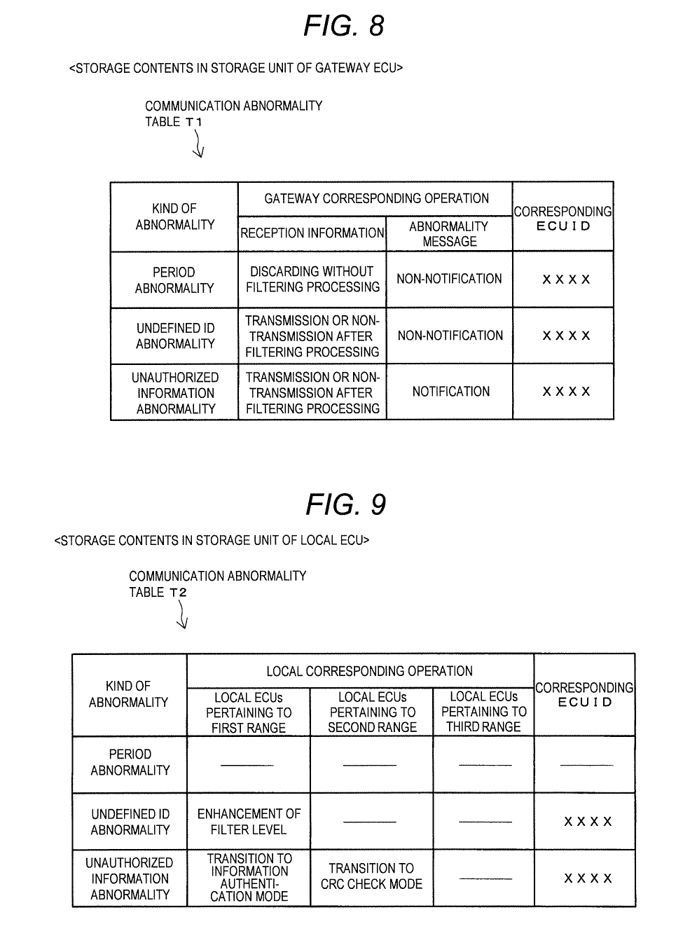

FIG. 9 is a view illustrating an example of the storage contents of the storage unit 25 of the local ECUs 2. A communication abnormality table T2 relating to a communication abnormality as illustrated in FIG. 9 is stored in a predetermined storage region of the storage unit 25. In this example, examples of “kind of abnormality” in the communication abnormality table T2 include “period abnormality”, “undefined ID abnormality”, and “unauthorized information abnormality”. Among these, only the “undefined ID abnormality” is an abnormality that can be detected by the local ECUs 2 (the abnormality detection unit 22). The “unauthorized information abnormality” is an abnormality that is detected by the gateway ECU 1 and is given in notification to the local ECUs 2 (refer to FIG. 8). The “period abnormality” is an abnormality that is detected by the gateway ECU 1, but is not given in notification to the local ECUs 2 (refer to FIG. 8). In this example, the “period abnormality” is an abnormality which the local ECUs 2 fail to notice. As another example, the local ECUs 2 may detect the “period abnormality”.

“Local corresponding operation” in the communication abnormality table T2 represents a control operation relating to security of the local ECUs 2 in correspondence with the kind of each abnormality. “Corresponding ECU ID” represents an ID of a local ECU 2 that is a transmission source for which the kind of each abnormality is detected. Furthermore, the “period abnormality” is an abnormality which the local ECUs 2 fail to notice, and thus “local corresponding operation” corresponding to the “period abnormality” is not set, and the “corresponding ECU ID” corresponding to the “period abnormality” is always in a state of not recorded. In FIG. 9, a not-set and not-recorded state is indicated by a horizontal line “-”. In the “local corresponding operation”, a section in which the horizontal line is shown represents that a corresponding operation is not performed even though an abnormality is detected.

For example, when an ID, which matches an ID of the local ECU 2 that is a transmission source of the information received in step S21 in FIG. 4, does not exist in the column of “corresponding ECU ID” in the communication abnormality table T2, the control unit 21 of the local ECUs 2 on a reception side determines that an abnormal record of the local ECU 2 that is a transmission source is not stored (NO in step S26 in FIG. 4). In this case, the control unit 21 executes a control of the in-vehicle apparatus that is an object to be controlled on the basis of the information received from the local ECU 2 that is a transmission source through the gateway ECU 1 (step S29 in FIG. 4).

On the other hand, in a case where the information transmitted from the local ECU 2 that is a transmission source is abnormal information, the abnormality detection unit 12 of the gateway ECU 1 that receives the information detects an abnormality in step S3 in FIG. 4 on the basis of the information, and additionally detects the kind of the abnormality. In this manner, when an abnormality is detected by the abnormality detection unit 12 (YES in step S4 in FIG. 4), the control unit 11 records the contents of the abnormality in the storage unit 15 (step S5 in FIG. 4). Specifically, an ID of the local ECU 2 that is a transmission source (hereinafter, referred to as “abnormal information transmission source”) that transmits the abnormality-detected information is recorded in the column of “corresponding ECU ID”, which corresponds to the kind of the abnormality detected by the abnormality detection unit 12, in the communication abnormality table T1 (FIG. 8) stored in the storage unit 15.

Next, the abnormality notification unit 13 executes first abnormality notification processing in correspondence with the kind of the abnormality detected by the abnormality detection unit 12 (step S6 in FIG. 4). At this time, the abnormality notification unit 13 determines notification/non-notification of an abnormality message including the kind of abnormality in correspondence with the kind of the abnormality detected by the abnormality detection unit 12 with reference to the communication abnormality table T1 (FIG. 8) stored in the storage unit 15. In addition, in a case of determination as notification, respective local ECUs 2 are notified of the abnormality message by the transmission unit 18, and in a case of determination as non-notification, the respective local ECUs 2 are not notified of the abnormality message.

Specifically, as illustrated in the communication abnormality table T1 in FIG. 8, in a case where the “period abnormality” or the “undefined ID abnormality” is detected by the abnormality detection unit 12, the abnormality notification unit 13 does not notify the local ECUs 2 of the abnormality message. In addition, in a case where the “unauthorized information abnormality” is detected by the abnormality detection unit 12, the abnormality notification unit 13 notifies the local ECUs 2 of the abnormality message including the contents of the unauthorized information abnormality. A notification destination of the abnormality message includes the local ECUs 2 on a reception side which are combined in the in-vehicle communication system 100 other than the local ECU 2 that is a transmission source.

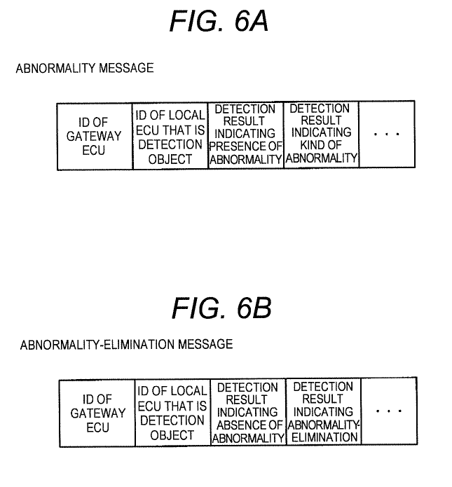

FIGS. 6A and 6B are views illustrating an example of a message that is given in notification to the local ECUs 2 from the gateway ECU 1. FIG. 6A illustrates an abnormality message that is given in notification to the local ECUs 2 from the gateway ECU 1. The abnormality message includes an ID of the gateway ECU 1, an ID of a local ECU 2 that is an abnormality detection object, a detection result indicating presence of an abnormality, a detection result indicating the kind of the abnormality, and the like.

After passage of the predetermined time after execution of the first abnormality notification processing, the abnormality notification unit 13 executes a second abnormality notification processing (step S7 in FIG. 4). The second abnormality notification processing is the same as the first abnormality notification processing. According to this, in a case where the abnormality message is transmitted to the local ECUs 2 through the first abnormality notification processing, the same abnormality message is also transmitted to the local ECUs 2 even in the second abnormality notification processing. As another example, the abnormality message (FIG. 6A) that is given in notification of each abnormality notification processing may include information indicating the number of times of the notification.

Then, the gateway unit 14 executes gateway processing in abnormality in correspondence with the kind of abnormality that is detected by the abnormality detection unit 12 (step S8 in FIG. 4). At this time, the gateway unit 14 subjects information received from the local ECU 2 that is a transmission source to gateway processing in correspondence with the kind of the abnormality detected by the abnormality detection unit 12 with reference to the communication abnormality table T1 (FIG. 8) stored in the storage unit 15.

Specifically, as illustrated in the communication abnormality table T1 in FIG. 8, in a case where the “period abnormality” is detected by the abnormality detection unit 12, information (large amount of information) received from the local ECU 2 that is a transmission source is discarded by the gateway unit 14 without being subjected to the filtering processing. In contrast, in a case where the “undefined ID abnormality” or the “unauthorized information abnormality” is detected by the abnormality detection unit 12, reception information received from the local ECU 2 that is a transmission source is subjected to the filtering processing (and/or communication protocol conversion processing) by the gateway unit 14, and is transmitted or not transmitted to the local ECUs 2 on a reception side.

A format (not illustrated) of information that is transmitted (relayed) to the local ECUs 2 on a reception side by the gateway ECU 1 is approximately the same as a format of information transmitted from the local ECU 2 that is a transmission source in FIG. 5A (not illustrated). As another example, the information, which is transmitted to the local ECUs 2 on a reception side by the gateway ECU 1, may include information indicating relaying by the gateway ECU 1 in addition to contents in FIG. 5A.

In the local ECUs 2 on a reception side, for example, the abnormality message, which is transmitted from the gateway ECU 1 through the first or second abnormality notification processing by the gateway ECU 1, is received by the reception unit 27 (YES in step S31 in FIG. 4). In this case, the abnormality detection unit 22 detects occurrence of an abnormality and the kind of the abnormality on the basis of the abnormality message. In addition, the control unit 21 records contents of the abnormality detected by the abnormality detection unit 22 in the storage unit 25 (step S32 in FIG. 4).

As described above, only the “unauthorized information abnormality” as the kind of abnormality is included in the abnormality message from the gateway ECU 1. According to this, in step S32 in FIG. 4, an ID of a local ECU 2 that is an abnormal information transmission source is recorded in the column (hereinafter, referred to as “ID column of unauthorized information abnormality) of “corresponding ECU ID” at a right end of a row of “unauthorized information abnormality” in the communication abnormality table T1 (FIG. 8) stored in the storage unit 15.

In addition, the security switching unit 23 executes security conversion processing on the basis of the kind of abnormality (unauthorized information abnormality) detected by the abnormality detection unit 22, and the communication abnormality table T2 (FIG. 9) stored in the storage unit 25 (step S33 in FIG. 4). At this time, the security switching unit 23 switches a security operation in accordance with the “unauthorized information abnormality” in the communication abnormality table T2, and a situation of the local ECUs 2.

In FIG. 9, as illustrated in the column of “unauthorized information abnormality” in the communication abnormality table T2, for example, in local ECUs 2 pertaining to a first range (to be described later) of the in-vehicle communication system 100, it transitions to information authentication mode by the security switching unit 23. In the information authentication mode, first, the control unit 21 records an ID, which is included in the abnormality message from the gateway ECU 1, of a local ECU 2 that is a detection object in the ID column of unauthorized information abnormality in the communication abnormality table T2 as an unauthorized ID. Then, in communication with the local ECU 2 corresponding to the unauthorized ID, the information authentication unit 24 detects authentication information (encryption keys, counter information, and the like) included in reception information as illustrated in FIG. 5B from the reception information received through the gateway ECU 1, and performs authentication of the reception information on the basis of the authentication information. In addition, in a case where the authentication succeeds, the control unit 21 executes a control of the in-vehicle apparatus on the basis of the reception information.

For example, the “local ECUs pertaining to a first range” include local ECUs 2 in the same network as that of the local ECU 2 that is a detection object indicated by the abnormality message (FIG. 6A), and local ECUs 2 which do not exist in the same network as that of the local ECU 2 that is a detection object but need information transmitted from the local ECU 2 that is a detection object. Furthermore, in the local ECUs 2, information (ID and the like) relating to other local ECUs 1 and 2, with which communication is necessary, is stored in the storage unit 25 in advance. In addition, the authentication information may always be included in information that is communicated between the local ECUs 2 as illustrated in FIG. 5B, or after the local ECUs 2 transition to the information authentication mode, the authentication information may be included in information that is subsequently transmitted to other local ECUs 2.

In addition, for example, in local ECUs 2 pertaining to a second range (to be described later) of the in-vehicle communication system 100, it transitions to a CRC (cyclic redundancy check) check mode by the security switching unit 23. In the CRC check mode, in communication between the local ECUs 2, the control unit 21 of a local ECU 2 that is a transmission source performs a predetermined operation on the basis of a data string of information to calculate a check value, and adds the check value to transmission information (CRC check value in FIG. 5C). In addition, the control unit 21 of local ECUs 2 on a reception side compares a value obtained through a predetermined operation based on a data string of necessary information that is received, and the check value, thereby determining information validity.

For example, the “local ECUs pertaining to a second range” are local ECUs 2 in the same network as that of the local ECU 2 that needs information transmitted from a local ECU 2 that is a detection object indicated by the abnormality message (FIG. 6A). In addition, the CRC check value may always be included in information that is communicated between the local ECUs 2 as illustrated in FIG. 5C, or after the local ECUs 2 transition to the CRC check mode, the CRC check value may be included in information that is subsequently transmitted to other local ECUs 2.

In addition, for example, in local ECUs 2 pertaining to a third range of the in-vehicle communication system 100, the security operation is not switched by the security switching unit 23. That is, a current security operation is maintained. The “local ECUs pertaining to a third range” are local ECUs 2 which are not included in the first range and the second range. Specifically, for example, the local ECUs pertaining to the third range are local ECUs 2 which do not exist in the same network as that of the local ECU 2 that is a detection object, and local ECUs 2 which need information transmitted from the local ECU 2 that is a detection object.

In local ECUs 2 on a reception side, for example, information transmitted from the gateway ECU 1 after the above-described gateway processing in abnormality of the gateway ECU 1 is received by the reception unit 27. In addition, in local ECUs 2 on a reception side in which the control unit 21 determines that necessary information is received (YES in step S21 in FIG. 4), the abnormality detection unit 22 executes abnormality detection processing of an undefined ID on the basis of the reception information (step S22 in FIG. 4).

At this time, in a case where the undefined ID is included in the reception information, the abnormality detection unit 22 detects abnormality (undefined ID abnormality) (YES in step S23 in FIG. 4). In this case, the control unit 21 records contents of the abnormality in the storage unit 25 (step S24 in FIG. 4). Specifically, an ID of a local ECU 2 that is an abnormal information transmission source is recorded in the column (hereinafter, referred to as “ID column of undefined ID abnormality”) of “corresponding ECU ID” at a right end of a row of “undefined ID abnormality” in the communication abnormality table T2 (FIG. 9) stored in the storage unit 25.

In addition, the security switching unit 23 executes security switching processing on the basis of the kind (undefined ID abnormality) of the abnormality that is detected, and the communication abnormality table T2 (step S25 in FIG. 4). At this time, the security switching unit 23 of the local ECUs 2 on a reception side switches a security operation in accordance with the “undefined ID abnormality” in the communication abnormality table T2 in FIG. 9, and a situation of the local ECUs 2.

As described above, local ECUs 2, which need the information transmitted from the local ECU 2 that is a transmission source, are the local ECUs 2 pertaining to the first range of the in-vehicle communication system 100, and thus a filtering level is enhanced by the security switching unit 23. Specifically, first, the control unit 21 of the local ECUs 2 records an undefined ID, which is included in information received from the local ECU 2 that is a transmission source through the gateway ECU 1, in the ID column of undefined ID abnormality in FIG. 9. Then, even when receiving information including the same undefined ID, the information is excluded from an object of reception processing and control processing.

In addition, the control unit 21 executes a control of the in-vehicle apparatus that is an object to be controlled on the basis of the information received from the local ECU 2 that is a transmission source through the gateway ECU 1 (step S29 in FIG. 4). At this time, control contents may be set to be different from each other between a case where the “undefined ID abnormality” is detected and a case where the “undefined ID abnormality” is not detected on the basis of the received information.

On the other hand, in a case where the undefined ID is not included in the information received from the local ECU 2 that is a transmission source through the gateway ECU 1, the abnormality detection unit 22 does not detect an abnormality (NO in step S23 in FIG. 4). In this case, the control unit 21 determines whether or not an abnormality record of the local ECU 2 that is a transmission source is recorded in the storage unit 25 (step S26 in FIG. 4).

At this time, in a case where an ID, which matches the ID of the local ECU 2 that is a transmission source of the information received in step S21 in FIG. 4, exists in the ID column of undefined ID abnormality in the communication abnormality table T2 (FIG. 9), the control unit 21 determines that an abnormality record of the local ECU 2 that is a transmission source is stored in the storage unit 25 (YES in step S26 in FIG. 4). In this case, the control unit 21 determines that the “undefined ID abnormality” is eliminated, and erases the abnormality record of the local ECU 2 that is a transmission source (step S27 in FIG. 4). That is, the ID of the local ECU 2 that is a transmission source is erased from the ID column of undefined ID abnormality in the communication abnormality table T2.

In addition, the security switching unit 23 executes security returning processing (step S28 in FIG. 4). At this time, the security switching unit 23 returns the security operation to a typical state. That is, the filtering level when receiving information is returned to a typical level. Then, the control unit 21 executes a control of the in-vehicle apparatus that is an object to be controlled on the basis of information received from the local ECU 2 that is a transmission source through the gateway ECU 1 (step S29 in FIG. 4).

Then, information from a local ECU 2 that is a transmission source is transmitted again (step S1 in FIG. 4). In this case, the information is received by the reception unit 17 of the gateway ECU 1 (YES in step S2 in FIG. 4), and the abnormality detection unit 12 executes the abnormality detection processing on the basis of the information (step S3 in FIG. 4). At this time, in a case where the abnormality detection unit 12 does not detect an abnormality (NO in step S4 in FIG. 4), the control unit 11 determines whether or not an abnormality record of the local ECU 2 that is a transmission source is stored in the storage unit 15 (step S9 in FIG. 4).

For example, in a case where an ID, which matches the ID of the local ECU 2 that is a transmission source of the information received in step S2 in FIG. 4, exists in the column of “corresponding ECU ID” in the communication abnormality table T1, the control unit 11 determines that an abnormality record of the local ECU 2 that is a transmission source is stored (YES in step S9 in FIG. 4). In this case, absence of an abnormality is detected on the basis of information received again from the local ECU 2 that is a transmission source, and thus the control unit 11 determines that abnormality of the local ECU 2 that is a transmission source is eliminated, and erases the abnormality record of the corresponding local ECU 2 that is a transmission source (step S10 in FIG. 4).

Next, the abnormality notification unit 13 executes first abnormality-elimination notification processing (step S11 in FIG. 4). At this time, the abnormality notification unit 13 notifies local ECUs 2, which are previously notified of an abnormality message, of an abnormality-elimination message indicating elimination of the abnormality by using the transmission unit 18.

Information illustrated in FIG. 6B is an abnormality-elimination message that is given in notification to the local ECUs 2 from the gateway ECU 1. The abnormality-elimination message includes an ID of the gateway ECU 1, an ID of a local ECU 2 that is a detection object, a detection result indicating absence of an abnormality, a detection result indicating elimination of an abnormality, and the like. The kind of the abnormality that is eliminated may also be included in the abnormality-elimination message.

After passage of the predetermined time after execution of the first abnormality-elimination notification processing, the abnormality notification unit 13 executes second abnormality-elimination notification processing (step S12 in FIG. 4). The second abnormality-elimination notification processing is the same as the above-described first abnormality-elimination notification processing. According to this, for example, in a case where an abnormality-elimination message is transmitted to the local ECUs 2 through the first abnormality-elimination notification processing, the same abnormality-elimination message is also transmitted to the local ECUs 2 even in the second abnormality-elimination notification processing. As another example, the abnormality-elimination message that is given in notification of each abnormality-elimination notification processing may include information indicating the number of times of the notification.

Then, the gateway unit 14 executes typical gateway processing (step S13 in FIG. 4). According to this, the information received from the local ECU 2 that is a transmission source is subjected to filtering processing by the gateway unit 14, and is transmitted or not transmitted to the local ECUs 2 on a reception side.

In the local ECUs 2 on a reception side, for example, the abnormality-elimination message, which is transmitted from the gateway ECU 1 through the first abnormality-elimination notification processing and the second abnormality-elimination notification processing of the gateway ECU 1, is received by the reception unit 27 (YES in step S34 in FIG. 4). In this case, the control unit 21 determines that the abnormality (unauthorized information abnormality) relating to the local ECU 2 that is a transmission source is eliminated on the basis of the abnormality-elimination message. In addition, the control unit 21 erases the abnormality record (ID) of the local ECU 2 that is a transmission source in the communication abnormality table T2 (FIG. 9) stored in the storage unit 25 (step S35 in FIG. 4). Specifically, the ID of the local ECU 2 that is a transmission source is erased from the ID column of the unauthorized information abnormality in the communication abnormality table T2.

In addition, the security switching unit 23 executes security returning processing (step S36 in FIG. 4). At this time, the security switching unit 23 returns the security operation to a typical state. That is, the security operation is returned to a state before the notification of the abnormality message indicating the kind of the abnormality that is eliminated at that time.

In addition, in the local ECUs 2 on a reception side, the reception unit 27 receives information that is transmitted (relayed) in the typical gateway processing (step S13 in FIG. 4) by the gateway ECU 1. In addition, in a case where the control unit 21 determines that necessary information is received (YES in step S21 in FIG. 4), the processing in step S22 to the processing in step S29 in FIG. 4 are executed in the above described order.

According to the above-described embodiment, the gateway ECU 1 detects an abnormality and the kind of the abnormality on the basis of information received from any one of the local ECUs 2, and notifies other local ECUs 2 of the kind of abnormality in correspondence with the kind of the abnormality. In addition, the gateway ECU 1 transmits the received information to other local ECUs 2 in correspondence with the kind of abnormality. In addition, each of the local ECUs 2 performs a control such as a security operation in correspondence with the kind of the abnormality that is given in the notification from the gateway ECU 1, and executes a control of an object to be controlled on the basis of information received from other local ECUs 2 through the gateway ECU 1.

According to this, in communication between the local ECUs 2 through the gateway ECU 1, the gateway ECU 1 and the local ECUs 2 are allowed to appropriately operate in correspondence with the kind of abnormality that occurs, and thus it is possible to ensure communication properties between the local ECUs 2 and security of the local ECUs 2. In addition, the gateway ECU 1 does not perform a control with respect to the local ECUs 2 in correspondence with detection of an abnormality, and the local ECUs 2 perform a control in correspondence with the kind of the abnormality that is given in notification. That is, the local ECUs 2 determine the behavior thereof in correspondence with the kind of the abnormality given in notification from the gateway ECU 1 and spontaneously operate, and thus it is possible to reduce a burden on the gateway ECU 1.

In addition, in the above-described embodiment, in correspondence with the kind of the abnormality in communication between the local ECUs 2 through the gateway ECU 1, the information is given to not only a local ECU 2 that needs the information but also other local ECUs 2. According to this, it is possible to allow the local ECUs 2 to appropriately operate in correspondence with the kind of the abnormality that occurs in the in-vehicle communication system 100. In addition, the gateway ECU 1 notifies the entirety of the local ECUs 2 except for the local ECU 2 that is an abnormal information transmission source of the kind of the abnormality, and thus it is possible to further reduce a burden on the gateway ECU 1 in comparison to a case where a notification destination is set to a specific local ECU 2.

In the above-described embodiment, the local ECUs 2 switch a security operation in correspondence with the kind of that abnormality that is given in notification from the gateway ECU 1. According to this, the security operation in communication between the local ECUs 2 is appropriately switched in correspondence with the kind of the abnormality that occurs in a local ECU 2 that is an information transmission source, and thus it is possible to further improve communication security.

In addition, in the above-described embodiment, in a case where an abnormality is not detected by the abnormality detection unit 12 on the basis of information received again from the local ECU 2 that is an abnormal information transmission source, the abnormality notification unit 13 notifies the local ECUs 2, which are notified of the kind of the abnormality, of elimination of the abnormality. The local ECUs 2 return to a control state before notification of the kind of abnormality in response to notification of the abnormality-elimination from the gateway ECU 1. According to this, when an abnormality in communication between the local ECUs 2 is eliminated, the local ECUs 2 are returned to a typical control state, and thus it is possible to improve communication properties between the local ECUs 2. In addition, when the security operation in abnormality is executed in the local ECUs 2, a processing burden on the local ECUs 2 increases. However, in this embodiment, when the abnormality is eliminated, the local ECUs 2 return to the typical control state, and thus it is possible to reduce the processing burden on the local ECUs 2.

In addition, in the above-described embodiments, the abnormality notification unit 13 of the gateway ECU 1 executes each of the abnormality notification processing and the abnormality-elimination notification processing a plurality of times at a predetermined period. According to this, the local ECUs 2 which are notification destination are reliably notified of an abnormality message including the kind of abnormality and an abnormality-elimination message, and thus it is possible to allow the local ECUs 2 to execute an appropriate control.

In addition, in the above-described embodiment, when the abnormality detection unit 12 of the gateway ECU 1 detects a period abnormality such as DOS attack, information that is received is discarded. According to this, even when a large amount of information is transmitted to the gateway ECU 1 due to the period abnormality, the gateway ECU 1 is suppressed from entering a high load state, and thus communication between other local ECUs 2 through the gateway ECU 1 becomes possible. As a result, it is possible to allow the local ECUs 2 to appropriately execute a control.

In addition, in the above-described embodiment, in a case where the abnormality detection unit 12 of the gateway ECU 1 detects an undefined ID abnormality as the kind of abnormality, the abnormality notification unit 13 does not notify the local ECUs 2 of the undefined ID abnormality, but the gateway unit 14 transmits information including the undefined ID to local ECUs 2 on a reception side. In addition, when detecting the undefined ID and the undefined ID abnormality on the basis of information received from the gateway ECU 1, the local ECUs 2 excludes the reception information including the undefined ID from an object to be processed. That is, even when an ID undefined in the gateway ECU 1 is included in the information received from the local ECU 2 that is a transmission source, the information is transmitted to local ECUs 2 on a reception side by the gateway ECU 1, and thus it is possible to secure communication properties. In addition, in the local ECUs 2, when an ID undefined in the local ECUs 2 is included in information received from the local ECU 2 that is a transmission source through the gateway ECU 1, the reception information including the undefined ID is excluded from an object to be processed, and thus it is possible to ensure security of the local ECUs 2. In addition, information, which is transmitted from an unauthorized device that is improbable on networks of the in-vehicle communication system 100, is excluded from an object to be processed in the local ECUs 2, and thus it is possible to reduce a burden on the gateway ECU 1.

In addition, in the above-described embodiment, in a case where the abnormality detection unit 12 of the gateway ECU 1 detects the unauthorized information abnormality as the kind of abnormality, the abnormality notification unit 13 notifies the local ECUs 2 of an abnormality message including the unauthorized information abnormality and an ID of a local ECU 2 that is a detection object (transmission source) of the abnormality. In addition, the gateway unit 14 transmits information received from the local ECU 2 that is a transmission source, to local ECUs 2 on a reception side. In addition, the local ECUs 2 store the ID, which is included in the abnormality message received from the gateway ECU 1, of the local ECU 2 that is a detection object as an unauthorized ID. When receiving information including the unauthorized ID, authentication of the information is performed, and when the authentication succeeds, a control is executed on the basis of the information. That is, even when the information received from the local ECU 2 that is a transmission source is unauthorized information, the information is transmitted to the local ECUs 2 on a reception side by the gateway ECU 1 in combination with the abnormality message, and thus it is possible to ensure communication properties. In addition, in the local ECUs 2, even when detecting the unauthorized ID from the abnormality message that is given in notification from the gateway ECU 1, and then receiving information including the unauthorized ID, authentication of the information is performed, and a control is executed on the basis of the information only when the authentication succeeds. Accordingly, it is possible to ensure security of the local ECUs 2 and the in-vehicle apparatus that is an object to be controlled. In addition, the local ECUs 2 authenticate unauthorized information transmitted from an unauthorized device that imitates a local ECU 2 on a network of the in-vehicle communication system 100, and determines whether or not the information is reliable information. Accordingly, it is possible to reduce a burden on the gateway ECU 1.

The invention can employ various embodiments in addition to the above-described embodiment. For example, in the above-described embodiment, description has been given of an example in which the local ECUs 2 other than a local ECU 2, for which the abnormality is detected, is notified of the abnormality message including the kind of the abnormality in correspondence with the kind of the abnormality that is detected in the gateway ECU 1, but the invention is not limited thereto. For example, the gateway ECU may notify only a local ECU, which needs reception information, of the abnormality message in correspondence with the kind of the abnormality which is detected on the basis of the reception information from any one local ECU. In addition, the abnormality message may be given in notification to a specific local ECU such as a local ECU that is in the same network as that of a local ECU that is a transmission source of the abnormal information or a local ECU that needs the abnormal information in correspondence with the kind of the abnormality detected by the abnormality detection unit. In addition, the local ECU that is an abnormal information transmission source may also be notified of the abnormality message. That is, at least a local ECU, which needs the abnormal information, may be notified of the abnormality message. In addition, the abnormality-elimination message may be given in notification to the same notification destination as that of the abnormality message.

In addition, in the above-described embodiment, a description has been given of an example in which the gateway ECU 1 executes each of the abnormality notification processing and the abnormality-elimination notification processing two times at a predetermined period, but the invention is not limited thereto. Each of the abnormality notification processing and the abnormality-elimination notification processing may be executed once or three or more times. That is, the number of times of notification of the abnormality message including the kind of abnormality and the like, and the abnormality-elimination message indicating elimination of the abnormality may be one or more times. In a case where the number of times of execution of the abnormality notification processing and the abnormality-elimination notification processing decreases, it is possible to reduce a processing burden on the gateway ECU 1. In addition, in a case where the number of times of execution of the abnormality notification processing and the abnormality-elimination notification processing increases, the number of times of notification of abnormality-elimination message increases, and thus it is possible to improve reception properties in local ECUs which are notification destinations.

In addition, in the above-described embodiment, description has been given of an example in which the gateway ECU 1 individually transmits the abnormality message and the abnormality-elimination message, and relaying information to the local ECUs 2 on a reception side, but the invention is not limited thereto. For example, in a case where the gateway ECU 1 transmits the abnormality information and the abnormality-elimination message, and relaying information in correspondence with the kind of the abnormality that is detected, the abnormality message and the abnormality-elimination message, and the relaying information may be collectively transmitted to the local ECU 2 on a reception side.

In addition, in the above-described embodiment, description has been given of an example in which the local ECUs 2 switch the security operation in correspondence with the kind of abnormality given in notification from the gateway ECU 1, but the invention is not limited thereto. For example, the local ECUs 2 may switch a control other than the security operation, and a control of the in-vehicle apparatus that is an object to be controlled in correspondence with the kind of abnormality given in notification from the gateway ECU 1.

In addition, in the above-described embodiment, description has been given of an example in which the abnormality detection unit 12 of the gateway ECU 1 detects a period abnormality, an undefined ID abnormality, or an unauthorized information abnormality, but the invention is not limited thereto. The abnormality detection unit 12 may detect at least two abnormalities among the abnormalities and other abnormalities in communication. In addition, operations (the abnormality notification processing, the abnormality-elimination notification processing, the gateway processing, and the like) of the gateway ECU 1, and operations (the security switching processing, the in-vehicle apparatus control, and the like) of the local ECUs 2 in correspondence with the kind of the abnormality may be set in advance.

In addition, in the above-described embodiment, a description has been given of an example in which among the local ECUs 2 on a reception side, a local ECU 2, which needs information transmitted from a local ECU 2 that is a transmission source, receives the information through the gateway ECU 1, and detects presence or absence of an abnormality on the basis of the information (steps S21 to S23 in FIG. 4), but the invention is not limited thereto. For example, when the local ECUs 2 on a reception side receive information from the local ECU 2 that is a transmission source through the gateway ECU 1, presence or absence of an abnormality may be detected on the basis of the information regardless of the necessity of the information. In this case, after detection of presence or absence of the abnormality, recording processing of abnormality contents, confirmation processing of an abnormality record, security switching processing, and the like on the basis of the detection result as in steps S24 to S28 in FIG. 4. In addition, after the execution, the local ECUs 2 on a reception side may determine whether or not the received information is information necessary for a control of the in-vehicle apparatus that is an object to be controlled. In a case where the received information is necessary information, the local ECUs 2 on a reception side may execute control of the in-vehicle apparatus that is an object to be controlled on the basis of the information (step S29 in FIG. 4), and may discard the information without execution of the control of the in-vehicle apparatus that is an object to be controlled. In addition, as another example, in communication between the local ECUs 2 without through the gateway ECU 1, the local ECUs 2 on a reception side may detect an abnormality on the basis of information received from a local ECU 2 that is an information transmission source, and may perform a control such as security switching in correspondence with the kind of the abnormality. In addition, an abnormality that is detected by the local ECUs 2 is not limited to the undefined ID abnormality, and may be the period abnormality such as DOS attack, the unauthorized information abnormality, or abnormalities other than the above-described abnormalities.

In addition, in the above-described embodiment, description has been given of an example in which when the gateway ECU 1 relays (transmits) information received from a local ECU 2 that is a transmission source, the information is transmitted in a manner capable of being received the entirety of the local ECUs 2, but the invention is not limited thereto. For example, data indicating a local ECU that is a transmission destination of the information or a network (identification information such as an ID, a port, and a bus) may be included in the information (FIG. 5) transmitted from a local ECU that is a transmission source, and the gateway ECU, which receives the information from the local ECU that is a transmission source, may transmit the information only to the local ECU that is a transmission destination, or the network on the basis of data of the transmission destination which is included in the information.

In addition, in the above-described embodiment, description has been given of an example in which the gateway ECU 1 is used as the communication management device, and the local ECUs 2 are used as the vehicle control device, but the invention is not limited thereto. Other communication-possible devices may be used as the communication management device or the vehicle control device.

In addition, in the above-described embodiment, description has been given of an example in which the invention is applied to the in-vehicle communication system 100 that is mounted on the vehicle 30 as an automatic four-wheel vehicle. However, for example, the invention is also applicable to an in-vehicle communication system that is mounted on other vehicles such as an automatic two-wheel vehicle or a large-sized vehicle.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An in-vehicle communication system, comprising:
a plurality of vehicle control devices which are connected to a network constructed in a vehicle and perform a mutual communication so as to control respective units of the vehicle; and
a communication management device that is connected to the network and manages communication between the vehicle control devices,
wherein during communication between the vehicle control devices, information transmitted from any one of the vehicle control devices is received by other vehicle control devices through the communication management device,
wherein the communication management device comprises:
an abnormality detection unit that detects an abnormality and a kind of the abnormality on the basis of reception information that is received from the any one of the vehicle control devices during communication between the vehicle control devices;
an abnormality notification unit that notifies the other vehicle control devices of the kind of the abnormality in correspondence with the kind of the abnormality; and
a transmission control unit that transmits the reception information to the other vehicle control devices in correspondence with the kind of the abnormality, and
wherein the vehicle control devices execute a predetermined control in correspondence with the kind of the abnormality that is given in notification from the communication management device.

2. The in-vehicle communication system according to claim 1,
wherein a plurality of the networks are constructed in the vehicle,
wherein the plurality of vehicle control devices and the communication management device as a single common device are connected to the networks, and
wherein the abnormality notification unit of the communication management device notifies the vehicle control devices of the kind of the abnormality in correspondence with the kind of the abnormality detected by the abnormality detection unit.

3. The in-vehicle communication system according to claim 1,
wherein the vehicle control devices switch a security operation for ensuring communication security in correspondence with the kind of the abnormality that is given in notification from the communication management device.

4. The in-vehicle communication system according to claim 1,
wherein in a case where an abnormality is not detected by the abnormality detection unit on the basis of information received again from a vehicle control device, in which an abnormality has been detected, among the vehicle control devices, the communication management device notifies the vehicle control devices, which have been notified of the kind of the abnormality, of abnormality-elimination by using the abnormality notification unit, and
wherein the vehicle control devices are returned to a control state before notification of the kind of the abnormality, in response to the notification of the abnormality-elimination from the communication management device.

5. The in-vehicle communication system according to claim 4,
wherein the abnormality notification unit of the communication management device executes notification of the kind of the abnormality or notification of the abnormality-elimination a plurality of times at a predetermined period.

6. The in-vehicle communication system according to claim 1,
wherein in a case where the abnormality detection unit of the communication management device detects a period abnormality, in which a large amount of information greater than a constant amount is transmitted in a period that obstructs a normal communication, as the kind of abnormality,
the abnormality notification unit of the communication management device does not give a notification of the period abnormality, and
the transmission control unit discards the large amount of information.

7. The in-vehicle communication system according to claim 1,
wherein in a case where the abnormality detection unit of the communication management device detects an identification information abnormality in which identification information, which is included in the reception information received from the any one of the vehicle control devices, of a transmission source is not defined as the kind of abnormality,
the abnormality notification unit does not give a notification of the identification information abnormality,
the transmission control unit transmits the reception information to the other vehicle control devices, and
the vehicle control devices detect the identification information abnormality on the basis of the information received through the communication management device, store the undefined identification information included in the information, and exclude the information from an object to be processed even when receiving information including the undefined identification information.

8. The in-vehicle communication system according to claim 1,
wherein in a case where the abnormality detection unit of the communication management device detects an unauthorized information abnormality, in which information received from the any one of the vehicle control devices is unauthorized, as the kind of abnormality,
the abnormality notification unit notifies the vehicle control devices of an abnormality message including the unauthorized information abnormality and identification information, which is included in the reception information, of a transmission source,
the transmission control unit transmits the reception information to the other vehicle control devices, and
the vehicle control devices, which are notified of the abnormality message, store the identification information, which is included in the abnormality message, of the transmission source as unauthorized identification information, performs authentication of reception information when receiving the information including the unauthorized identification information, and executes a predetermined control on the basis of the reception information when the authentication succeeds.

9. A communication management device that is connected to a network constructed in a vehicle, manages communication between a plurality of vehicle control devices which are connected to the network, and receives information transmitted from any one of the vehicle control devices and transmits the reception information to other vehicle control devices in communication between the vehicle control devices, the communication management device comprising:
an abnormality detection unit that detects an abnormality and a kind of the abnormality in communication between the vehicle control devices on the basis of the reception information received from the any one of the vehicle control devices;
an abnormality notification unit that notifies the other vehicle control devices of the kind of the abnormality in correspondence with the kind of the abnormality; and
a transmission control unit that transmits the reception information to the other vehicle control devices in correspondence with the kind of the abnormality.

10. A vehicle control device, which is one of a plurality of the vehicle control devices being connected to a network constructed in a vehicle to perform a mutual communication and controlling respective units of the vehicle, and information transmitted from any one of the vehicle control devices being received by other vehicle control devices through a communication management device connected to the network in communication between the vehicle control devices,
wherein the vehicle control device receives an abnormality notification message, which includes an abnormality detected by the communication management device on the basis of the transmitted information, and a kind of the abnormality, from the communication management device,
wherein the vehicle control device receives the transmitted information from the communication management device in correspondence with the kind of the abnormality, and
wherein the vehicle control device executes a predetermined control in correspondence with the kind of the abnormality included in the abnormality notification message.
